(19) United States
(12) Patent Application Publication
(10) Pub. No.: US 2019/0185003 A1
(43) Pub. Date: Jun. 20, 2019

(54) POWER TRANSMISSION APPARATUS

(71) Applicant: EXEDY Corporation, Osaka (JP)

(72) Inventors: Keiji SATO, Osaka (JP); Yuki KAWAHARA, Osaka (JP); Hitoshi KATSURA, Osaka (JP); Kimitaka UEMURA, Osaka (JP); Chika BABA, Osaka (JP)

(73) Assignee: EXEDY Corporation

(21) Appl. No.: 16/212,542

(22) Filed: Dec. 6, 2018

(30) Foreign Application Priority Data
Dec. 19, 2017 (JP) 2017-242491

(51) Int. Cl. B60W 30/18; B60W 10/02; B60W 10/08; B60W 10/196

(52) U.S. Cl. CPC B60W 30/18127; B60W 10/023; B60W 10/02; B60W 10/08; B60W 10/196; B60W 2710/021; B60Y 2200/91; B60W 2030/1809; B60W 2510/244; B60W 2520/105; B60W 30/18072

(57) ABSTRACT

A power transmission apparatus transmits torque from a rotating electric machine and includes a first path, a second path, a clutch, and a fluid coupling. The second path is provided parallel to the first path. The clutch is provided on the first path. The clutch can assume an engaged state that transmits torque and a disengaged state that stops transmission of the torque. The fluid coupling is provided on the second path. The fluid coupling includes an input member into which the torque from the rotating electric machine is input, and an output member that outputs the torque input from the input member via a fluid to a drive wheel. The fluid coupling is configured such that a rotation speed of the input member is lower than a rotation speed of the output member when transmitting the torque from the drive wheel to the rotating electric machine side.

### CROSS-REFERENCES TO RELATED APPLICATIONS

This application claims priority to Japanese Patent Application No. 2017-242491, filed Dec. 19, 2017. The contents of that application are herein incorporated by reference in their entirety.

### BACKGROUND

### Technical Field

The present disclosure relates to a power transmission apparatus.

### Background Art

Vehicles such as electric vehicles and hybrid vehicles, which use rotating electric machines as motive power sources, can use regenerative brakes at a time of deceleration. Moreover, these vehicles can charge batteries with the power generated by the regenerative brakes.

### BRIEF SUMMARY

However, with configurations such as that described above, there are situations in which the regenerative brake is unusable. Examples of such cases include when the charging capacity of the battery has reached the upper limit. In such cases, it is useful to provide other braking means.

As such, an object of the present disclosure is to provide a variety of braking means.

### Solutions to Problems

A power transmission apparatus according to an aspect of the present disclosure is configured to transmit torque from a rotating electric machine to a drive wheel. This power transmission apparatus includes a first path, a second path, a clutch, and a fluid coupling. The first path and the second path are paths that transmit the torque from the rotating electric machine to the drive wheel, and are provided parallel to each other. The clutch is provided on the first path. The clutch can assume an engaged state that transmits the torque and a disengaged state that stops the transmission of the torque. The fluid coupling is provided on the second path. In other words, the fluid coupling is provided parallel to the clutch. The fluid coupling includes an input member into which the torque from the rotating electric machine is input, and an output member that outputs the torque input from the input member via a fluid to the drive wheel. The fluid coupling is configured such that a rotation speed of the input member is lower than a rotation speed of the output member when transmitting the torque from the drive wheel to the rotating electric machine side.

As a result of this configuration, at a time of deceleration, braking force by the regenerative brake can be obtained by transmitting the torque from the drive wheel to the rotating electric machine via the clutch. Additionally, by setting the clutch to the disengaged state, the torque from the drive wheel can be transmitted to the rotating electric machine via the fluid coupling. The fluid coupling is configured such that the rotation speed of the input member is lower than the rotation speed of the output member when transmitting the torque from the drive wheel to the rotating electric machine side. As such, braking force on the rotation of the drive wheel can be obtained by the resistance of the fluid interposed between the input member and the output member. Thus, with the power transmission apparatus according to the present advancement, a variety of braking means for braking the rotation of the drive wheel can be provided.

Since the fluid coupling is configured such that the rotation speed of the input member is lower than the rotation speed of the output member, when transmitting the torque from the drive wheel to the rotating electric machine via the fluid coupling, the power generation amount by the rotating electric machine can be reduced compared to when transmitting the torque via the clutch, or the rotating electric machine can be set to a non-generating state. This is useful when the charge amount of a power storage unit is near the upper limit or has reached the upper limit.

Note that the concept of the rotation speed of the input member being lower than the rotation speed of the output member includes, for example, a mode in which the output member is rotating but the rotation of the input member is stopped. Additionally, the concept of the rotation speed of the input member being lower than the rotation speed of the output member includes a mode in which the output member rotates forward but the input member rotates in reverse.

It is preferable that the power transmission apparatus further includes a control unit. At a time of deceleration, the control unit can control the rotation of the input member and the state of the clutch in a first mode and a second mode. In the first mode, the control unit sets the clutch to the disengaged state and stops the rotation of the input member. In the second mode, the control unit sets the clutch to the disengaged state and rotates the input member in reverse.

It is preferable that, at a time of deceleration, the control unit can control at least one of the rotation of the input member, the state of the rotating electric machine, and the state of the clutch in the first mode, the second mode, a third mode, or a fourth mode. In the third mode, the control unit sets the clutch to the disengaged state, allows the input member to freely rotate, and sets the rotating electric machine to the non-generating state. In the fourth mode, the control unit sets the clutch to the disengaged state and sets the rotating electric machine to a generating state.

It is preferable that the control unit selects one of the first mode and the second mode on the basis of a deceleration rate that is requested.

It is preferable that the control unit selects one of the first mode to the fourth mode on the basis of a deceleration rate that is requested.

It is preferable that the power transmission apparatus further includes a power storage unit that exchanges power with the rotating electric machine. At a time of deceleration, the control unit selects one of the first mode, the second mode, and a fifth mode according to a charge state of the power storage unit. In the fifth mode, the control unit sets the clutch to the engaged state and sets the rotating electric machine to the generating state.

It is preferable that the power transmission apparatus further includes a power storage unit that exchanges power with the rotating electric machine. At a time of deceleration, the control unit selects one of the first mode to the fourth mode or a fifth mode according to a charge state of the power storage unit. In the fifth mode, the control unit sets the clutch to the engaged state and sets the rotating electric machine to the generating state.

It is preferable that the input member is capable of reverse rotation.

It is preferable that the clutch is a normally closed type clutch.

It is preferable that the power transmission apparatus further includes a locking mechanism that stops the rotation of the input member. Note that the concept of the locking mechanism includes not only mechanisms that mechanically stop the rotation of the input member, but also mechanisms that electrically stop the rotation of the input member.

It is preferable that the power transmission apparatus further includes a decelerating mechanism disposed between the rotating electric machine, and the clutch and the fluid coupling.

It is preferable that the power transmission apparatus further includes a forward-reverse switching mechanism disposed between the clutch and the fluid coupling, and the drive wheel.

According to the present disclosure, a variety of braking means can be provided.

### BRIEF DESCRIPTION OF THE DRAWINGS

FIG. 1 is a block diagram of a power transmission apparatus;

FIG. 2 is a flowchart explaining the operations of a control unit at a time of deceleration;

FIG. 3 is a flowchart explaining the operations of the control unit when coasting;

FIG. 4 is a flowchart explaining the operations of the control unit when decelerating; and

FIG. 5 is a block diagram of a power transmission apparatus according to a modification example.

### DETAILED DESCRIPTION OF THE PREFERRED EMBODIMENTS

In the following, embodiments of the power transmission apparatus according to the present disclosure will be described with reference to the attached drawings. Note that, in the following description, the term. “forward rotation” means rotation in the direction that causes the vehicle move forward, and the term. “reverse rotation” means rotation in the direction that causes the vehicle to move backward.

Overall Configuration

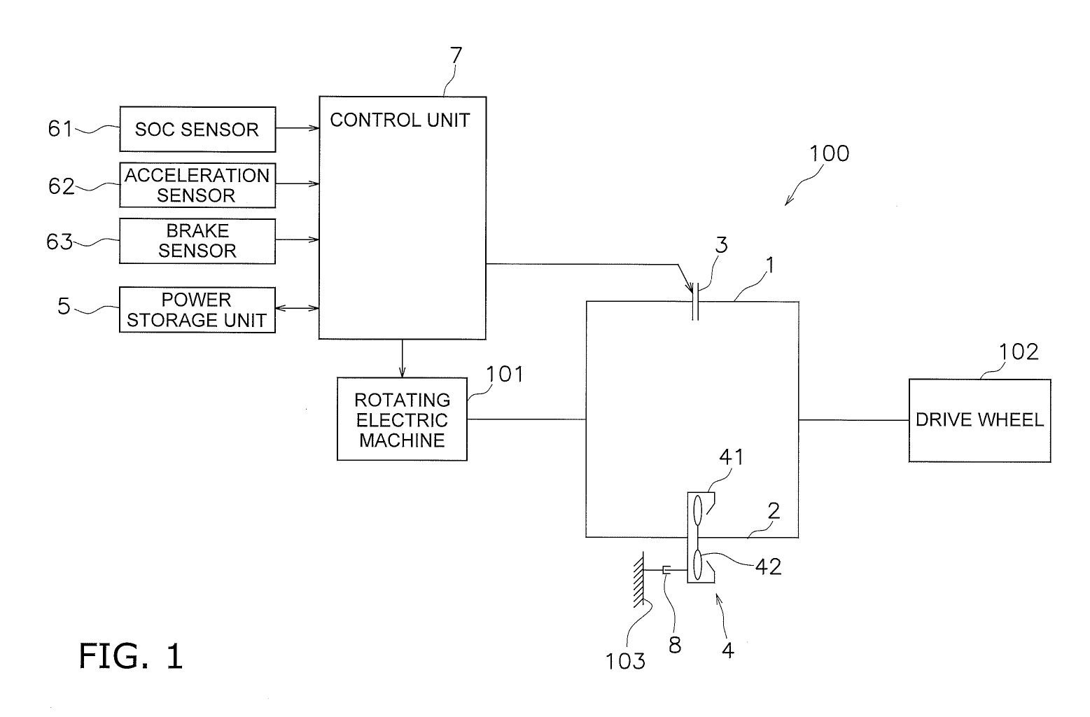

As illustrated in FIG. 1, a power transmission apparatus 100 is configured to transmit torque from a rotating electric machine 101 to a drive wheel 102. Note that the power transmission apparatus 100 is also capable of transmitting torque from the drive wheel 102 to the rotating electric machine 101 at a time of deceleration. That is, the power transmission apparatus 100 is configured to transmit torque between the rotating electric machine 101 and the drive wheel 102. In one example, this power transmission apparatus 100 is applied to an electric vehicle. The power transmission apparatus 100 includes a first path 1, a second path 2, a clutch 3, a fluid coupling 4, a power storage unit 5, various sensors 61 to 63, a control unit 7, and a locking mechanism 8.

First Path and Second Path

The first path 1 and the second path 2 are paths that transmit torque from the rotating electric machine 101 to the drive wheel 102. The first path 1 and the second path 2 are provided parallel to each other. That is, when the torque from the rotating electric machine 101 is transmitted to the drive wheel 102 via the first path 1, the second path 2 does not transmit the torque. Additionally, when the torque from the rotating electric machine 101 is transmitted to the drive wheel 102 via the second path 2, the first path 1 does not transmit the torque. Note that, when the clutch 3 is in a slip state (described later), the torque is transmitted via the first path 1 and the second path 2.

Clutch

The clutch 3 is provided on the first path 1. The clutch 3 is configured to be in an engaged state or a disengaged state. Note that the clutch 3 can also assume a slip state that corresponds to between the engaged state and the disengaged state. In the engaged state, the clutch 3 transmits torque between the rotating electric machine 101 and the drive wheel 102. In the disengaged state, the clutch 3 stops the transmission of torque between the rotating electric machine 101 and the drive wheel 102. The clutch 3 is a normally closed type clutch. That is, when the clutch 3 is not controlled by the control unit 7 to assume the disengaged state, the clutch 3 is in the engaged state. Moreover, the clutch 3 assumes the disengaged state when controlled by the control unit 7.

Fluid Coupling

The fluid coupling 4 is provided on the second path 2. The fluid coupling 4 includes an input member 41 and an output member 42. The input member 41 is connected to a member on the rotating electric machine 101 side. Torque from the rotating electric machine 101 is input into the input member 41. The input member 41 is provided so as to be capable of reverse rotation.

The output member 42 is connected to a member on the drive wheel 102 side. The output member 42 outputs the torque input from the input member 41 via a fluid to the drive wheel 102. Note that the space between the input member 41 and the output member 42 is filled with hydraulic oil, for example. The fluid coupling 4 can, for example, be configured by a torque converter or the like. That is, the input member 41 can be configured by an impeller of a torque converter and the output member 42 can be configured by a turbine of the torque converter. Moreover, the clutch 3 can be incorporated into the fluid coupling 4.

The fluid coupling 4 can amplify the torque when transmitting the torque from the rotating electric machine 101 to the drive wheel 102. For example, the fluid coupling 4 can include a stator for the purpose of torque amplification. The fluid coupling 4 is configured such that the rotation speed of the input member 41 is lower than the rotation speed of the output member 42 when transmitting the torque from the drive wheel 102 to the rotating electric machine 101 side.

Locking Mechanism

The locking mechanism 8 is configured to stop the rotation of the input member 41. In one example, the locking mechanism 8 is configured to brake the rotation of the input member 41. For example, the locking mechanism 8 releasably connects the input member 41 to a vehicle body 103.

When the locking mechanism 8 is in an ON state, the locking mechanism 8 connects the input member 41 to the vehicle body 103. Specifically, the locking mechanism 8 brakes the rotation of the input member 41. As a result, the input member 41 becomes unable to rotate. When the locking mechanism 8 is in an OFF state, the locking mechanism 8 releases the connection between the input member 41 and the vehicle body 103. Specifically, the locking mechanism 8 does not brake the rotation of the input member 41. As a result, the input member 41 becomes capable of rotation. Note that the control unit 7 controls the locking mechanism 8 to switch the locking mechanism 8 between the ON state and the OFF state.

Power Storage Unit

The power storage unit 5 is configured to exchange power with the rotating electric machine 101. That is, the power storage unit 5 is electrically connected to the rotating electric machine 101 and stores the power generated by the rotation of the rotating electric machine 101. Specifically, the power storage unit 5 is connected to the rotating electric machine 101 via an inverter circuit and a converter circuit of the control unit 7. Thus, the power storage unit 5 stores power that has been converted to DC power by the converter circuit.

The power stored in the power storage unit 5 can be supplied to the rotating electric machine 101 to rotate the rotating electric machine 101. Specifically, the DC power stored in the power storage unit 5 is converted to AC power by the inverter circuit of the control unit 7 and supplied to the rotating electric machine 101.

Sensors

The power transmission apparatus 100 includes various sensors. In one example, the power transmission apparatus 100 includes an SOC sensor 61 that detects an amount of stored power of the power storage unit 5, an acceleration sensor 62 that detects an amount of operation of the accelerator pedal, and a brake sensor 63 that detects an amount of operation of the brake pedal. The various sensors 61 to 63 output information acquired thereby to the control unit 7.

Control Unit

The control unit 7 is configured to control the rotation of the input member 41, the state of the rotating electric machine 101, the state of the clutch 3, and the state of the locking mechanism 8. Specifically, the control unit 7 includes an electronic control unit (ECU), a power control unit (PCU), and the like. The control unit 7 exchanges power between the rotating electric machine 101 and the power storage unit 5 via the inverter circuit and the converter circuit of the PCU. Additionally, the control unit 7 includes a hydraulic oil control circuit and the like for controlling the state of the clutch 3, the state of the locking mechanism 8, the amount of hydraulic oil in the fluid coupling 4, and the like.

At a time of deceleration, the control unit 7 implements one of a first to a fifth mode. In one example, the control unit 7 selects one of the first mode to the fifth mode according to a power storage state of the power storage unit 5 and a requested deceleration rate. Specifically, the control unit 7 selects either the fifth mode or a mode other than the fifth mode according to the power storage state of the power storage unit 5. Moreover, when a mode other than the fifth mode is selected, the control unit 7 also selects one of the first mode to the fourth mode according to the requested deceleration rate.

In the first mode, the control unit 7 sets the clutch 3 to the disengaged state and stops the rotation of the input member 41. That is, when the first mode is selected, the control unit 7 sets the clutch 3 to the disengaged state so that the torque from the drive wheel 102 is transmitted to the rotating electric machine 101 via the fluid coupling 4. Moreover, the control unit 7 sets the locking mechanism 8 to the ON state to stop the rotation of the input member 41. As a result, the rotation of the output member 42 is braked by the fluid resistance between the input member 41 and the output member 42 and, in turn, the rotation of the drive wheel 102 is braked.

In the second mode, the control unit 7 sets the clutch 3 to the disengaged state and rotates the input member 41 in reverse. That is, when the second mode is selected, the control unit 7 sets the clutch 3 to the disengaged state so that the torque from the drive wheel 102 is transmitted to the rotating electric machine 101 via the fluid coupling 4. Moreover, the control unit 7 uses the power stored in the power storage unit 5, for example, to rotate the rotating electric machine 101 in reverse so that the input member 41 rotates in reverse. As a result, the rotation of the output member 42 is braked by the fluid resistance between the input member 41 and the output member 42 and, in turn, the rotation of the drive wheel 102 is braked. Note that the fluid resistance between the input member 41 and the output member 42 in the second mode is greater than the fluid resistance in the first mode. As such, the braking force braking the rotation of the drive wheel 102 in the second mode is greater than the braking force in the first mode.

In the third mode, the control unit 7 sets the clutch 3 to the disengaged state, allows the input member 41 to freely rotate, and sets the rotating electric machine to 101 a non-generating state. That is, when the third mode is selected, the control unit 7 sets the clutch 3 to the disengaged state so that the torque from the drive wheel 102 is transmitted to the rotating electric machine 101 via the fluid coupling 4. Moreover, the control unit 7 sets the locking mechanism 8 to the OFF state so that the input member 41 will freely rotate, power is not supplied to the rotating electric machine 101, and the rotating electric machine 101 is not rotated in reverse. The control unit 7 also cuts off the circuit between the rotating electric machine 101 and the power storage unit 5 so as to place the rotating electric machine 101 in the non-generating state. The braking force in the third mode is less than the braking force in the first and second modes. Note that, in the third mode, since the rotating electric machine 101 is in the non-generating state, there is no braking force from the regenerative brake.

In the fourth mode, the control unit 7 sets the clutch 3 to the disengaged state and sets the rotating electric machine 101 to a generating state. That is, when the fourth mode is selected, the control unit 7 sets the clutch 3 to the disengaged state so that the torque from the drive wheel 102 is transmitted to the rotating electric machine 101 via the fluid coupling 4. The control unit 7 causes the power generated by the rotating electric machine 101 to be stored in the power storage unit 5 so as to place the rotating electric machine 101 in the generating state. In the fourth mode, since the rotating electric machine 101 functions as a generator, the rotation of the drive wheel 102 can be braked by the regenerative brake.

In the fifth mode, the control unit 7 sets the clutch 3 to the engaged state and sets the rotating electric machine 101 to the generating state. That is, when the fifth mode is selected, the control unit 7 sets the clutch 3 to the engaged state so that the torque from the drive wheel 102 is transmitted to the rotating electric machine 101 via the clutch 3. The control unit 7 causes the power generated by the rotating electric machine 101 to be stored in the power storage unit 5 so as to place the rotating electric machine 101 in the generating state. In the fifth mode, since the rotating electric machine 101 functions as a generator, the rotation of the drive wheel 102 can be braked by the regenerative brake. Note that, the braking force by the regenerative brake in the fifth mode is greater than the braking force of the regenerative brake in the fourth mode.

Control Method

Next, a control method for the power transmission apparatus 100 having the aforementioned configuration is described.

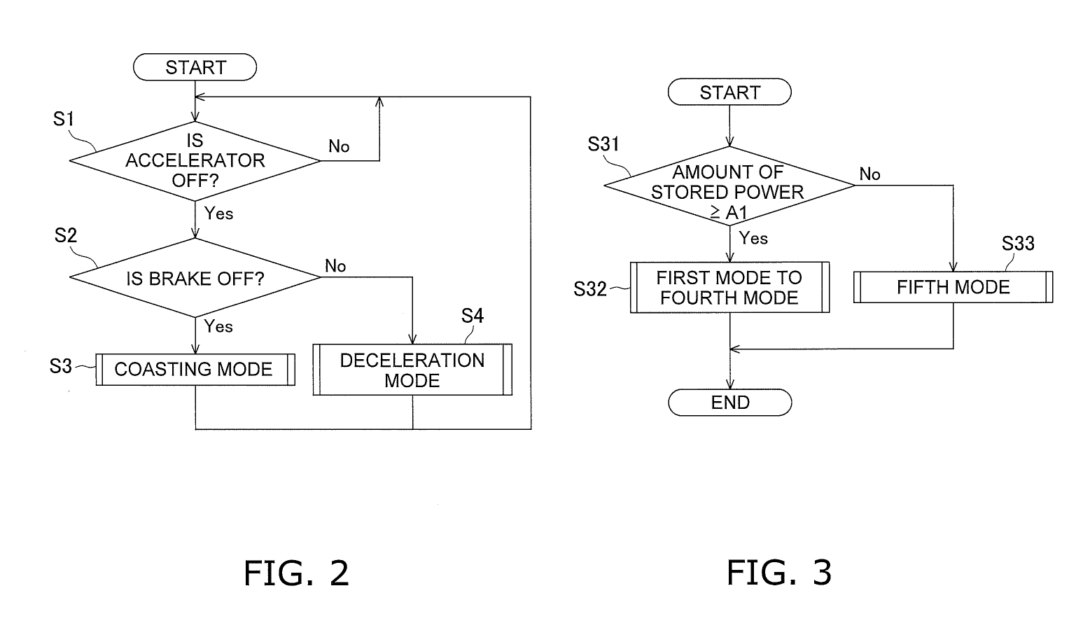

As illustrated in FIG. 2, the control unit 7 determines whether the accelerator pedal is not being operated (step S1). Specifically, the control unit 7 determines whether the accelerator pedal is not being operated on the basis of an amount of operation of the accelerator pedal detected by the acceleration sensor 62. When the control unit 7 determines that the accelerator pedal is being operated (step S1; No), the control unit 7 performs the processing of step S1 again.

When the control unit 7 determines that the accelerator pedal is not being operated (step S1; Yes), the control unit 7 subsequently determines whether the brake pedal is not being operated (step S2). Specifically, the control unit 7 determines whether the brake pedal is not being operated on the basis of an amount of operation of the brake pedal detected by the brake sensor 63.

When the control unit 7 determines that the brake pedal is not being operated (step S2; Yes), the control unit 7 performs processing of a coasting mode (step S3). When the control unit 7 determines that the brake pedal is being operated (step S2; No), the control unit 7 performs processing of a deceleration mode (step S4).

As illustrated in FIG. 3, in the coasting mode, the control unit 7 determines whether the amount of stored power of the power storage unit 5 is greater than or equal to a first threshold A1 (step S31). Specifically, the control unit 7 determines whether the amount of stored power of the power storage unit 5 is greater than or equal to the first threshold A1 on the basis of the amount of stored power detected by the SOC sensor 61.

When the control unit 7 determines that the amount of stored power of the power storage unit 5 is greater than or equal to the first threshold A1 (step S31; Yes), the control unit 7 performs the control processing of one of the first mode to the fourth mode described above (step S32). Note that, a configuration is possible in which, when the control unit 7 determines that the amount of stored power of the power storage unit 5 is greater than or equal to a second threshold A2 that is greater than the first threshold A1, the control unit 7 performs the control processing of one of the first mode to the third mode described above; and, when the control unit 7 determines that the amount of stored power is less than the second threshold A2, the control unit 7 performs the control processing of the fourth mode.

When the control unit 7 determines that the amount of stored power of the power storage unit 5 is less than the first threshold A1 (step S31; No), the control unit 7 performs control processing of the fifth mode described above (step S33).

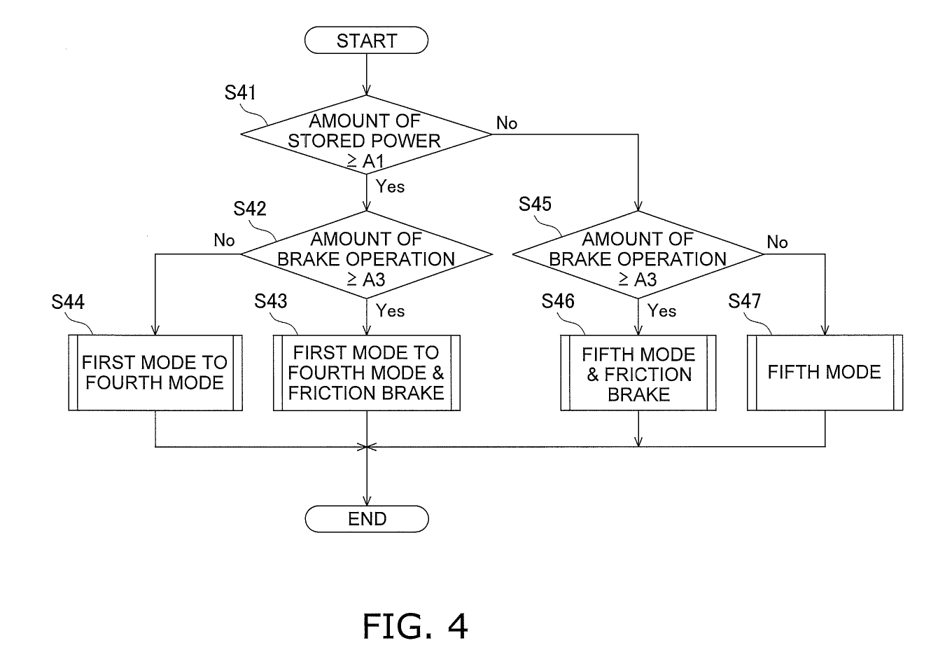

As illustrated in FIG. 4, in the deceleration mode, the control unit 7 determines whether the amount of stored power of the power storage unit 5 is greater than or equal to the first threshold A1 (step S41). Specifically, the control unit 7 determines whether the amount of stored power of the power storage unit 5 is greater than or equal to the first threshold A1 on the basis of the amount of stored power detected by the SOC sensor 61.

When the control unit 7 determines that the amount of stored power of the power storage unit 5 is greater than or equal to the first threshold A1 (step S41; Yes), the control unit 7 subsequently determines whether the amount of operation of the brake pedal is greater than or equal to a third threshold A3 (step S42). Specifically, the control unit 7 determines whether the amount of operation of the brake pedal is greater than or equal to the third threshold A3 on the basis of the amount of operation of the brake pedal detected by the brake sensor 63.

When the control unit 7 determines that the amount of operation of the brake pedal is greater than or equal to the third threshold A3 (step S42; Yes), the control unit 7 performs the control processing of one of the first mode to the fourth mode described above and causes a friction brake such as a disc brake or a drum brake to operate (step S43). Note that the control unit 7 selects one of the first mode to the fourth mode on the basis of the requested deceleration rate and, preferably, the control unit 7 selects the first mode or the second mode on the basis of the requested deceleration rate. Additionally, the control unit 7 can calculate the requested deceleration rate on, for example, the basis of the amount of operation of the brake pedal or the like.

When the control unit 7 determines that the amount of operation of the brake pedal is less than the third threshold A3 (step S42; No), the control unit 7 performs the control processing of one of the first mode to the fourth mode described above, but does not cause the friction brake to operate (step S44). Note that the control unit 7 selects one of the first mode to the fourth mode on the basis of the requested deceleration rate. The control unit 7 preferably selects the first mode or the second mode.

The processing of step S41 is returned to in order to continue the description of the control method. When the control unit 7 determines that the amount of stored power of the power storage unit 5 is less than the first threshold A1 (step S41; No), the control unit 7 subsequently determines whether the amount of operation of the brake pedal is greater than or equal to the third threshold A3 (step S45). Specifically, the control unit 7 determines whether the amount of operation of the brake pedal is greater than or equal to the third threshold A3 on the basis of the amount of operation of the brake pedal detected by the brake sensor 63.

When the control unit 7 determines that the amount of operation of the brake pedal is greater than or equal to the third threshold A3 (step S45; Yes), the control unit 7 performs the control processing of the fifth mode described above and causes the friction brake to operate (step S46).

When the control unit 7 determines that the amount of operation of the brake pedal is less than the third threshold A3 (step S45; No), the control unit 7 performs the control processing of the fifth mode described above, but does not cause the friction brake to operate (step S47).

### Modification Examples

While an embodiment of the present disclosure has been described, the present disclosure should not be construed as being limited thereto, and various types of modifications can be made without departing from the spirit or scope of the general inventive concept of the disclosure.

### Modification Example 1

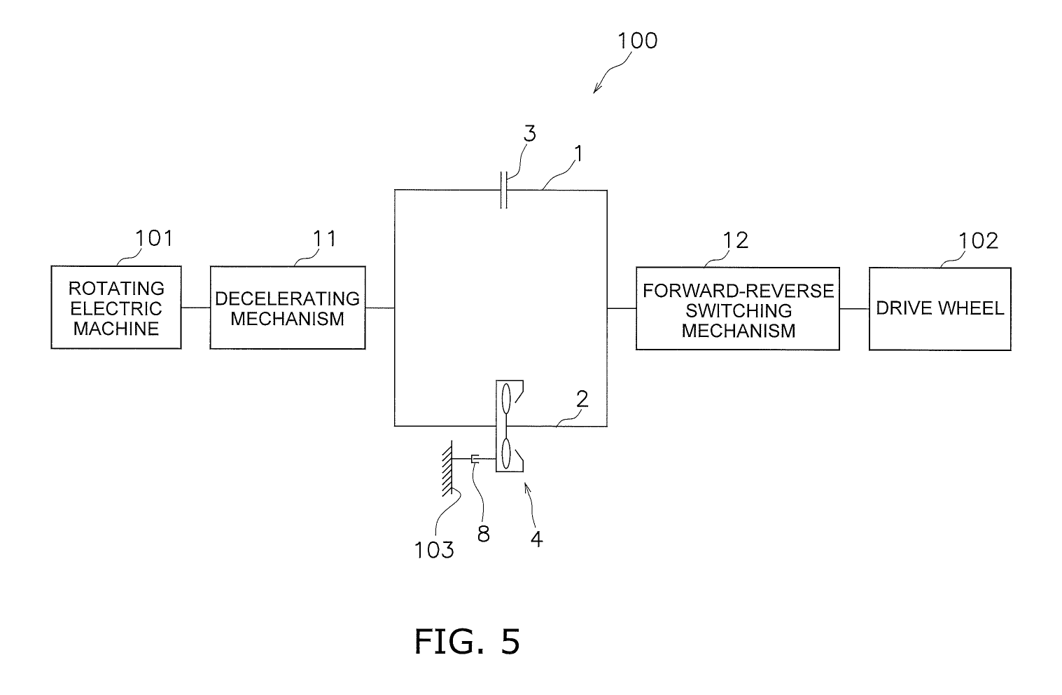

As illustrated in FIG. 5, the power transmission apparatus 100 can further include a decelerating mechanism 11. The decelerating mechanism 11 is disposed between the rotating electric machine 101, and the clutch 3 and the fluid coupling 4. In one example, the decelerating mechanism. 11 is configured by a plurality of gears, and decelerates the rotation speed of the rotating electric machine 101 to transmit to the clutch 3 or to the fluid coupling 4.

### Modification Example 2

The power transmission apparatus 100 can further include a forward-reverse switching mechanism 12. The forward-reverse switching mechanism 12 is disposed between the clutch 3 and the fluid coupling 4, and the drive wheel 102. In one example, the forward-reverse switching mechanism 12 is a dog clutch.

### Modification Example 3

In the embodiment described above, when the fifth mode is not selected, the control unit 7 selects one of the first mode to the fourth mode on the basis of the requested deceleration rate. However, the mode selected by the control unit 7 is not limited thereto. For example, when the control unit 7 does not select the fifth mode, the control unit 7 can select the first mode or the second mode on the basis of the requested deceleration rate. Additionally, when the control unit 7 does not select the fifth mode, the control unit 7 can select one of the first mode to the fourth mode regardless of the requested deceleration rate. For example, the control unit 7 can select either the first mode or the fifth mode and not select the second mode to the fourth modes. Additionally, the control unit 7 can select either the second mode or the fifth mode and not select the first mode, the third mode, and the fourth mode.

### Modification Example 4

In the embodiment described above, the locking mechanism 8 directly brakes the rotation of the input member 41, but a configuration is possible in which the locking mechanism 8 indirectly brakes the input member 41. For example, the locking mechanism 8 can indirectly brake the rotation of the input member 41 by braking the rotation of a member that rotates integrally with the input member 41.

### Modification Example 5

The control unit 7 can determine, on the basis of frictional heat, the mode to be selected. For example, a configuration is possible in which the control unit 7 determines whether the frictional heat is greater than or equal to a fourth threshold A4 and, when the frictional heat is greater than or equal to the fourth threshold A4, perform the control processing of the first mode or the second mode without causing the friction brake to operate.

### Modification Example 6

In the embodiment described above, the locking mechanism 8 is configured to mechanically stop the rotation of the input member 41. However, the method of stopping the rotation of the input member 41 is not particularly limited thereto. For example, the locking mechanism 8 can be configured to electrically stop the rotation of the input member 41.

Specifically, a configuration is possible in which the locking mechanism 8 stops the rotation of the input member 41 by electrically stopping the rotation of the rotating electric machine 101.

### Modification Example 7

A configuration is possible in which, in the first mode to the fourth mode described above, the control unit 7 further performs control to change the amount of oil in the fluid coupling 4 according to the requested deceleration rate. Additionally, a configuration is possible in which, in the second mode described above, the control unit 7 further performs control to change the reverse rotation speed of the input member 41 according to the requested deceleration rate. Moreover, a configuration is possible in which, in the fourth mode and the fifth mode, the control unit 7 further performs control to change the amount of regeneration of the rotating electric machine 101. These controls by the control unit 7 make it possible to change the braking force as desired.

### Modification Example 8

A configuration is possible in which, in the third mode, the control unit 7 further performs flux weakening control on the rotating electric machine 101.

### REFERENCE NUMERALS

1 First path
2 Second path
3 Clutch
4 Fluid coupling
41 Input member
42 Output member
5 Power storage unit
7 Control unit
8 Locking mechanism
100 Power transmission apparatus
101 Rotating electric machine
102 Drive wheel

What is claimed is:

1. A power transmission apparatus that transmits torque from a rotating electric machine to a drive wheel, the apparatus comprising:
a first path that transmits the torque from the rotating electric machine to the drive wheel;
a second path that is provided parallel to the first path and that transmits the torque from the rotating electric machine to the drive wheel;
a clutch that is provided on the first path, the clutch capable of assuming an engaged state that transmits the torque and a disengaged state that stops transmission of the torque; and
a fluid coupling that is provided on the second path, the fluid coupling including an input member into which the torque from the rotating electric machine is input, and an output member that outputs the torque input from the input member via a fluid to the drive wheel,
the fluid coupling configured such that a rotation speed of the input member is lower than a rotation speed of the output member when transmitting the torque from the drive wheel to the rotating electric machine side.

2. The power transmission apparatus according to claim 1, further comprising:
a control unit capable of controlling a rotation of the input member and a state of the clutch in a first mode and a second mode at a time of deceleration; wherein,
in the first mode, the control unit sets the clutch to the disengaged state and stops the rotation of the input member, and,
in the second mode, the control unit sets the clutch to the disengaged state and rotates the input member in reverse.

3. The power transmission apparatus according to claim 2, wherein,
at a time of deceleration, the control unit is capable of controlling at least one of the rotation of the input member, a state of the rotating electric machine, and a state of the clutch in the first mode, the second mode, a third mode, or a fourth mode,
in the third mode, the control unit sets the clutch to the disengaged state, allows the input member to freely rotate, and sets the rotating electric machine to a non-generating state, and,
in the fourth mode, the control unit sets the clutch to the disengaged state and sets the rotating electric machine to a generating state.

4. The power transmission apparatus according to claim 2, wherein
the control unit selects one of the first mode and the second mode on the basis of a deceleration rate that is requested.

5. The power transmission apparatus according to claim 3, wherein
the control unit selects one of the first mode to the fourth mode on the basis of a deceleration rate that is requested.

6. The power transmission apparatus according to claim 2, further comprising:
a power storage unit that exchanges power with the rotating electric machine, wherein,
at a time of deceleration, the control unit selects one of the first mode or the second mode, and a fifth mode according to a charge state of the power storage unit, and,
in the fifth mode, the control unit sets the clutch to the engaged state and sets the rotating electric machine to a generating state.

7. The power transmission apparatus according to claim 3, further comprising:
a power storage unit that exchanges power with the rotating electric machine, wherein,
at a time of deceleration, the control unit selects either one of the first mode to the fourth mode, or a fifth mode according to a charge state of the power storage unit, and,
in the fifth mode, the control unit sets the clutch to the engaged state and sets the rotating electric machine to the generating state.

8. The power transmission apparatus according to claim 7, wherein
the control unit selects one of the first mode to the fourth mode on the basis of a deceleration rate that is requested and a power storage state of the power storage unit.

9. The power transmission apparatus according to claim 2, wherein
the control unit changes at least one of an amount of oil in the fluid coupling, a reverse rotation speed of the input member, and an amount of regeneration of the rotating electric machine on the basis of a deceleration rate that is requested.

10. The power transmission apparatus according to claim 1, wherein
the input member is capable of reverse rotation.

11. The power transmission apparatus according to claim 1, wherein
the clutch is a normally closed type clutch.

12. The power transmission apparatus according to claim 1, further comprising:
a locking mechanism that stops a rotation of the input member.

13. The power transmission apparatus according to claim 1, further comprising:
a decelerating mechanism disposed between the rotating electric machine, and the clutch and the fluid coupling.

14. The power transmission apparatus according to claim 1, further comprising:
a forward-reverse switching mechanism disposed between the clutch and the fluid coupling, and the drive wheel.
